(19) United States
(12) Patent Application Publication
(10) Pub. No.: US 2015/0349911 A1
(43) Pub. Date: Dec. 3, 2015

(54) OPTICAL RECEIVER

(71) Applicant: Fujitsu Optical Components Limited, Kawasaki-shi (JP)

(72) Inventor: Koji Otsubo, Yokohama (JP)

(73) Assignee: FUJITSU OPTICAL COMPONENTS LIMITED, KAWASAKI (JP)

(21) Appl. No.: 14/826,561

(22) Filed: Aug. 14, 2015

Related U.S. Application Data
(63) Continuation of application No. PCT/JP2013/053875, filed on Feb. 18, 2013.

(51) Int. Cl. H04J 14/02; H04L 1/00; H04B 10/67

(52) U.S. Cl. CPC H04J 14/0221; H04B 10/673; H04L 1/0046

(57) ABSTRACT

An optical receiver includes a semiconductor optical amplifier configured to amplify an optical signal in which an optical signal with a first wavelength and an optical signal with a second wavelength are multiplexed. The receiver includes an optical demultiplexer configured to receive the optical signal amplified by the semiconductor optical amplifier and include a first filter configured to transmit the optical signal with the first wavelength with a transmission rate T1 and a second filter configured to transmit the optical signal with the second wavelength with a transmission rate T2. The receiver includes a first optical detector configured to receive the optical signal with the first wavelength from the optical demultiplexer. The receiver includes a second optical detector configured to receive the optical signal with the second wavelength from the optical demultiplexer. Further, the transmission rate T1 and the transmission rate T2 satisfy a relation T1>T2.

### CROSS-REFERENCE TO RELATED APPLICATION

This application is a continuation application of International Application PCT/JP2013/053875 filed on Feb. 18, 2013 and designated the U.S., the entire contents of which are incorporated herein by reference.

### FIELD

The embodiments discussed herein are related to an optical receiver.

### BACKGROUND

A WDM (Wavelength Division Multiplexing) scheme, in which a plurality of wavelengths are bundled and transmitted via an optical fiber, have been employed as a method of transmitting a large amount of information in the optical communication field. In 100 Gbps Ethernet (100GE), of which the standardization has been achieved, a WDM scheme in which four 25.8 Gbps signals are used has been employed. And CFP (100G Form-factor Pluggable) optical transceivers as optical modules have been developed. The types of CFP modules for 100GE are divided into LR4 (10 km) and ER4 (40 km) according to transmission distance. The CFP modules for ER4 employ an amplifier for optical intensity compensation.

### PRIOR ART DOCUMENTS

Patent document 1: Japanese Patent Application Laid-Open Publication No. 2003-283463

Patent document 2: Japanese Patent Application Laid-Open Publication No. 2005-27210

Patent document 3: Japanese Patent Application Laid-Open Publication No. 2010-98166

### SUMMARY

According to one embodiment, it is provided an optical receiver, including a semiconductor optical amplifier configured to amplify an optical signal in which an optical signal with a first wavelength and an optical signal with a second wavelength are multiplexed, an optical demultiplexer configured to receive the optical signal amplified by the semiconductor optical amplifier and include a first filter configured to transmit the optical signal with the first wavelength with a transmission rate T1 and a second filter configured to transmit the optical signal with the second wavelength with a transmission rate T2, a first optical detector configured to receive the optical signal with the first wavelength from the optical demultiplexer, and a second optical detector configured to receive the optical signal with the second wavelength from the optical demultiplexer, wherein the transmission rate T1 and the transmission rate T2 satisfy a relation T1>T2.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

FIG. 1 is a diagram schematically illustrating an example of an optical receiver included in a CFP module for 100GE ER4 according to an embodiment;

FIG. 2 is a diagram illustrating an example of a relation between wavelength of light input into an SOA and its gain;

FIG. 3 is a diagram illustrating an example of an optical communication system according to an embodiment;

FIG. 4 is a diagram illustrating an example of an optical receiver;

FIG. 5 is a diagram illustrating an example of control of a semiconductor optical amplifier of an optical receiver according to an embodiment;

FIG. 6 is a diagram illustrating an example of a configuration of an optical demultiplexer according to an embodiment;

FIG. 7 is a diagram illustrating an example of a configuration of an optical detector according to an embodiment;

FIG. 8 is a diagram illustrating an example of a configuration of a filter of an optical distributor according to an embodiment;

FIG. 9 is a diagram illustrating an example of an optical transmission path between the optical distributor and the optical detector in Configuration Example 3;

FIG. 10 is a diagram illustrating an example (1) of the intensity of light signals in the optical receiver;

FIG. 11 is a diagram illustrating an example (2) of the intensity of light signals in the optical receiver; and

FIG. 12 is a diagram illustrating an example (3) of the intensity of light signals in the optical receiver.

### DESCRIPTION OF EMBODIMENTS

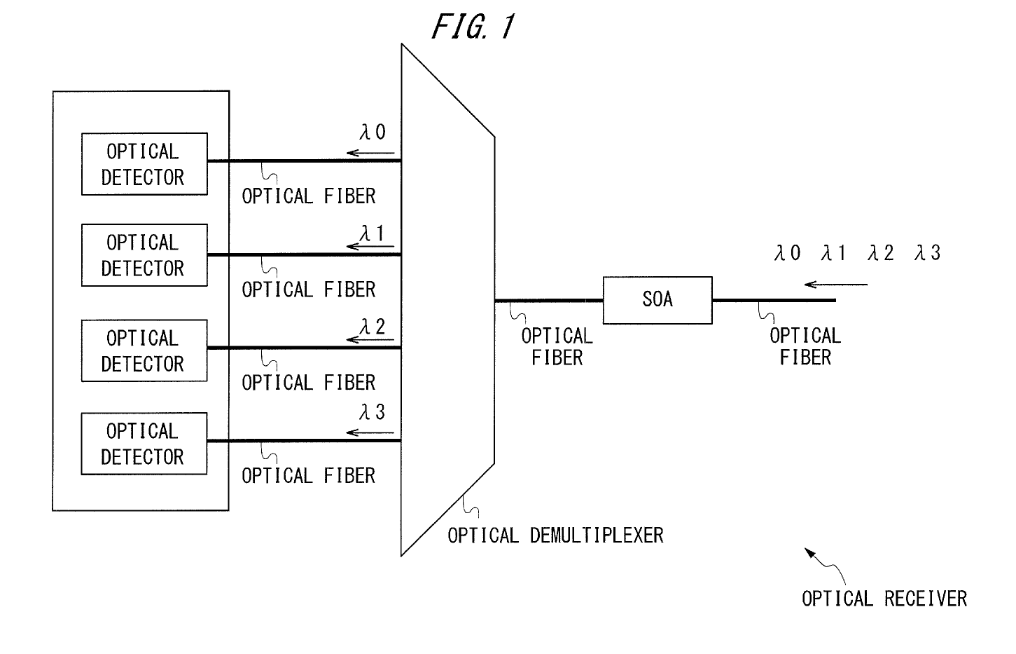

FIG. 1 is a diagram illustrating an optical receiver included in a CFP module for 100GE ER4. The optical receiver illustrated in FIG. 1 includes an optical fiber into which optical signals with a plurality of wavelengths are multiplexed and input, an SOA (Semiconductor Optical Amplifier), an optical demultiplexer, an optical fiber for connecting the SOA and the optical demultiplexer and an optical detector. The SOA is a small amplifier which can be installed in an optical transceiver. The optical demultiplexer outputs demultiplexed light which a multiplexed optical signal is demultiplexed into a plurality of wavelength channels. In an example illustrated in FIG. 1, the optical demultiplexer demultiplexes an optical signal into four wavelength channels. The optical detector detects the demultiplexed optical signals by wavelength channels and converts the optical signals into electric signals. In the optical receiver illustrated in FIG. 1, an optical signal with four wavelengths (λ0, λ1, λ2 and λ3 in ascending order of wavelength) transmitted by an optical fiber is passed through the SOA and divided according to the wavelengths by the optical demultiplexer. The optical detector detects each demultiplexed optical signal with each wavelength and converts the detected optical signals into electric signals. The number of wavelength channels is four for example. It can be understood that the number of wavelength channels is not limited to four.

The SOA is a device which injects electric current into a semiconductor and amplifies light by stimulated emission. When the SOA is used as an optical module such as CFP module, the electric current injected into the SOA is adjusted according to the power of transmitted light input into an optical receiver to control the optical power of the light input into an optical detector. The optical detector in the optical receiver has a minimum receiving sensitivity (Pmin) and a maximum receiving sensitivity (Pmax). When the intensity of the transmitted light is not between Pmin and Pmax, the transmitted information cannot be reproduced correctly since a bit-error-free operation cannot be achieved.

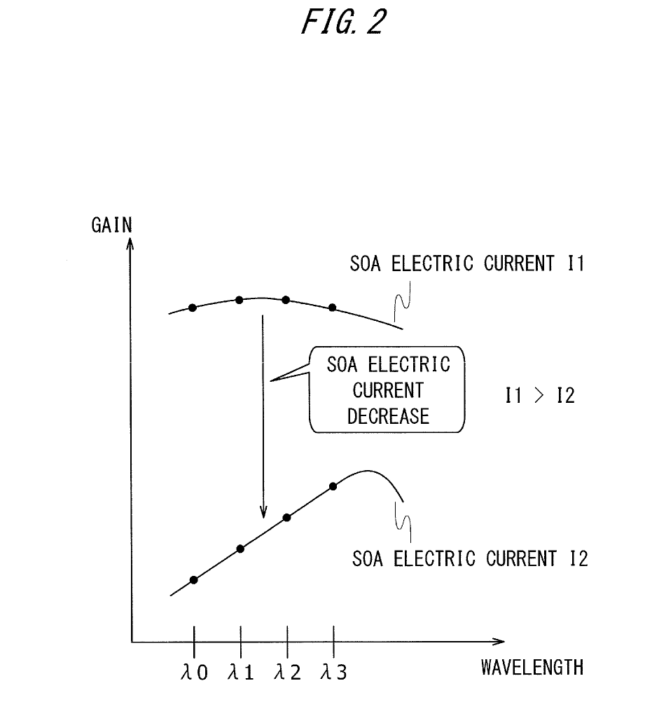

FIG. 2 is a diagram illustrating an example of a relation between wavelength and gain regarding light input into an SOA. The horizontal axis of the graph in FIG. 2 represents the wavelength of the light input into the SOA and the vertical axis represents the gain of the SOA. FIG. 2 illustrates a case in which the electric current injected into the SOA (SOA electric current) is I1 and a case in which the SOA electric current is I2 (<I1). As the intensity of the light input into the SOA increases, the amount of the light injected into the SOA is reduced not to let the intensity of the light input into the optical detector exceed the maximum reception sensitivity of the optical detector. As the amount of the electric current injected into the SOA decreases, a tilt occurs in the gain spectrum as illustrated by “SOA electric current I2” in FIG. 2 and the difference of gains from several dB to a dozen dB emerges between the shortest wavelength (λ0) and the longest wavelength (λ3) in the transmission wavelength range. This occurrence cannot be avoided as long as the SOA in which the gain spectrum can be changed according to the injected electric current is employed. The gain tilt widens the difference of the intensity of the light on the short wavelength side and on the long wavelength side in the transmission wavelength range. In this case, even when the SOA electric current is adjusted, the bit-error-free operation cannot be achieved in each wavelength channel if the intensity of the light of the shortest wavelength is equal to or smaller than Pmin of the optical detector or the intensity of the light of the longest wavelength is equal to or larger than Pmax. Namely, a bit error can occur in any one of the wavelength channels. Thus, the optical power in each wavelength channel should be equalized to solve the problem. That is, the optical power in each wavelength channel should be equal to or larger than Pmin of the optical detector and should be equal to or smaller than Pmax of the optical detector.

A technique has been employed for providing distributors to compensate the tilts of light transmission characteristics between light wavelengths occurred according to the number of reflections at filters by achieving the reversed tilts and equalizing the optical power for each wavelength channel. However, since the tilt of transmission characteristics occurred due to light loss by reflection at filters is smaller than 1 dB, using the above characteristics cannot sufficiently equalize the non-uniformity of the optical power occurred due to the gain tile of the SOA.

Another technique has been employed for using VOA (Variable Optical Attenuator) and variable spectrum equalizer to equalize the optical power. A CFP module is required to include optical devices such as alight source for four channels, an optical receiver, an SOA, an optical multiplexer and an optical demultiplexer in limited space. When a variable optical attenuator and a variable spectrum equalizer are employed, the number of optical elements increases and the cost of the optical receiver. In addition, control circuits for the optical elements are also used for controlling the optical receiver according to the input optical power. Therefore, the footprint of the optical elements increases. Thus, it is required to achieve a small footprint for optical elements and equalize the non-uniformity of the optical power, that is, the intensity of light signal for each wavelength channel occurred due to the gain tilt of the SOA.

With the above in mind, it is an object to provide an optical receiver for adjusting the optical power for each wavelength channel.

An embodiment is described below with reference to the drawings. A configuration of the following embodiment is an exemplification, and the present apparatus is not limited to the configuration of the embodiment.

In the present embodiment, it is assumed that there are four channels as wavelength channels. The wavelengths corresponding to the four channels are denoted as λ0, λ1, λ2 and λ3 in ascending order of wavelength.

The number of wavelength channels is not limited to four. For example, the number of wavelength channels may be two or five. When a configuration in which the number of wavelength channels is two is employed, the wavelengths λ0 and λ3 can be used.

### EMBODIMENTS

### Configuration Example

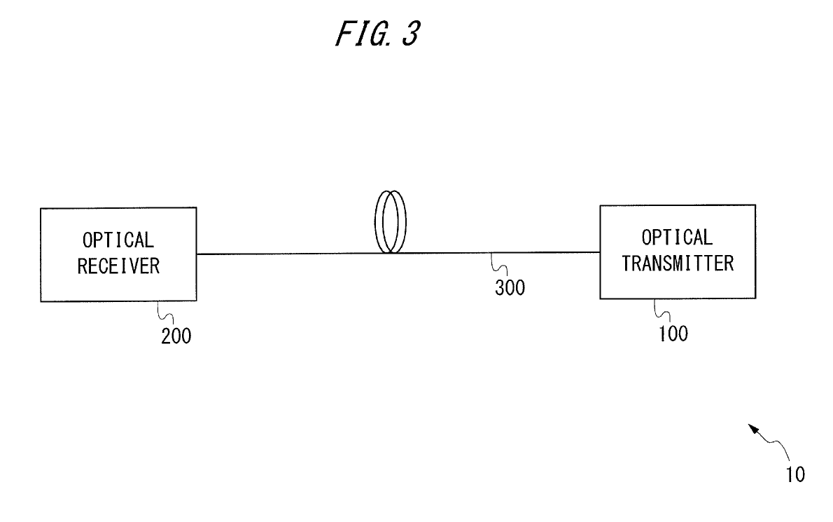

FIG. 3 is a diagram illustrating an example of an optical communication system according to the present embodiment. The optical communication system 10 includes an optical transmitter 100, an optical receiver 200 and an optical transmission path 300. The optical transmission path 300 connects the optical transmitter 100 with the optical receiver 200. An optical fiber exemplifies the optical transmission path 300.

The optical transmitter 100 transmits optical signals in a plurality of wavelength channels to the optical receiver 200 via the optical transmission path 300.

The optical receiver 200 receives the optical signals in the plurality of wavelength channels from the optical transmitter 100 via the optical transmission path 300. The optical signals in the plurality of wavelength channels are multiplexed. The optical receiver 200 demultiplexes the received optical signals by wavelength channels and converts the demultiplexed optical signals into electric signals.

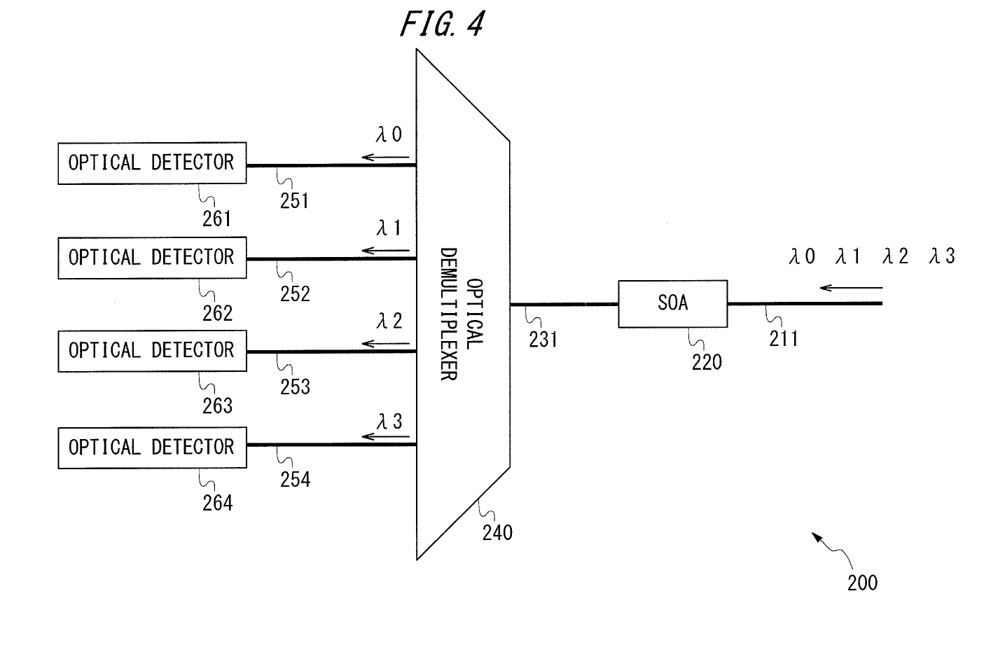

FIG. 4 is a diagram illustrating an example of the optical receiver. The optical receiver 200 in FIG. 4 includes an optical transmission path 211, a semiconductor optical amplifier (SOA) 220, an optical transmission path 231, an optical transmission path 251, an optical transmission path 252, an optical transmission path 253, an optical transmission path 254, an optical detector 261, an optical detector 262, an optical detector 263 and an optical detector 264.

Optical signals transmitted from the optical transmitter 100 etc. are input into the optical receiver 200. The optical signals are input into the optical receiver 200 via the optical transmission path 211.

The optical transmission path 211 connects external devices with the semiconductor optical amplifier 200. Each optical transmission path propagates optical signals. For example, optical fibers provide the transmission paths.

The semiconductor optical amplifier 220 amplifies the optical signals input via the optical transmission path 211 and outputs the amplified optical signals to the optical demultiplexer 240 via the optical transmission path 231.

For example, the semiconductor optical amplifier 220 includes an active layer, a p-type semiconductor layer and an n-type semiconductor layer sandwiching the active layer, a substrate, an electrode for electric current injection. The amplification factor of the semiconductor optical amplifier 220 varies according to the injected electric current. Specifically, the amplification factor of the semiconductor optical amplifier 220 depends on the electric current value and the wavelength of the injected electric current. Namely, when the injected electric current decreases as illustrated in FIG. 2, a tilt occurs in the gain spectrum of the semiconductor optical amplifier 220. In addition, the semiconductor optical amplifier 220 includes an electric current injection terminal, a TEC electric current terminal and a temperature monitoring terminal for temperature control, for example. And an optical transmission path for optical input and output is connected to the semiconductor optical amplifier 200.

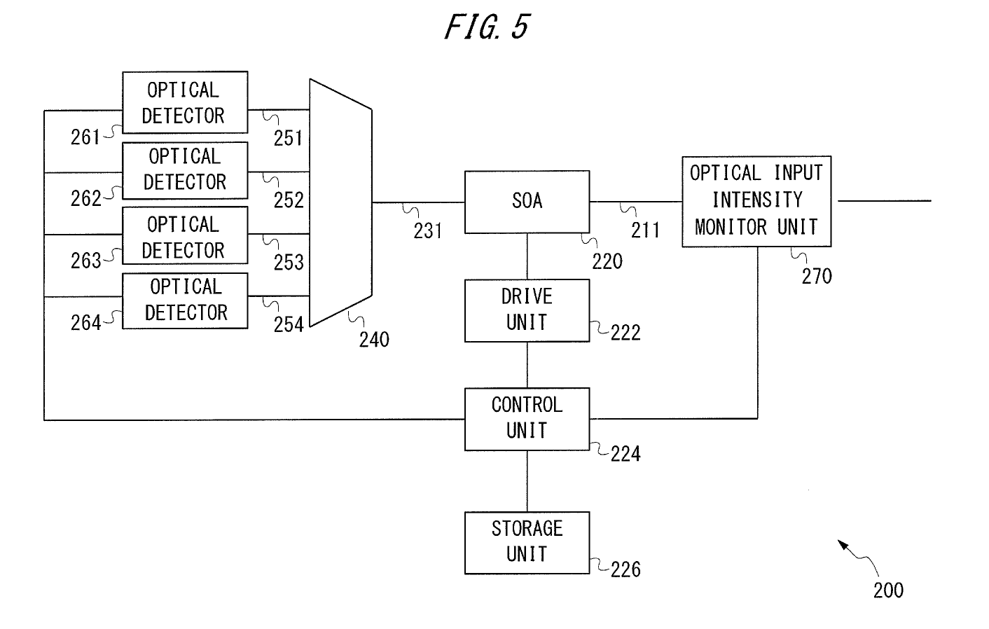

FIG. 5 is a diagram illustrating an example of the control of the semiconductor optical amplifier in the optical receiver. The optical receiver 200 in FIG. 5 includes a configuration which is omitted in the optical receiver 200 illustrated in FIG. 4. The optical receiver in FIG. 5 includes the semiconductor optical amplifier 220, a drive unit 222, a control unit 224, a storage unit 226 and an optical input intensity monitor unit 270.

The optical input intensity monitor unit 270 measures the intensity of the optical signals transmitted from the optical transmitter 100 etc. The optical input intensity monitor unit 270 notifies the control unit 224 of the measured optical input intensity of the received signals. The drive unit 222 injects electric current for driving the semiconductor optical amplifier 220 based on the information notified by the control unit 224. The optical detectors 261, 262, 263 and 264 measure the intensity of the received optical signals by wavelength and notify the control unit 224 of the measured intensity. The storage unit 226 stores the intensity of the optical signals measured by the optical input intensity monitor unit 270 and the intensity of the optical signals by wavelength measured by the optical detectors 261, 262, 263 and 264.

The control unit 224 calculates the amount of electric current injected into the semiconductor optical amplifier 220 based on the intensity of the optical signal measured by the optical input intensity monitor unit 270. The control unit 224 can calculate the amount of electric current injected into the semiconductor optical amplifier 220 based on the intensity of the optical signal measured by the optical input intensity monitor unit 270 and the intensity of the optical signal by wavelength measured by the optical detectors 261, 262, 263 and 264. The control unit 224 notifies the drive unit 222 of the calculated amount of electric current. The control unit 224 calculates the amount of electric current for which the intensity of the optical signal with the wavelength λ0 measured by the optical detector 261 can be larger than Pmin of the optical detector 261. In addition, the control unit 224 calculates the amount of electric current for which the intensity of the optical signal with the wavelength λ3 measured by the optical detector 264 can be smaller than Pmax of the optical detector 261.

The optical receiver 200 can be fabricated using a general-purpose computer such as Personal Computer (PC) or a dedicated computer such as server machine. The control unit 224 can be fabricated using a Central Processing Unit (CPU) or a Digital Signal Processor (DSP). The storage unit 226 can be fabricated using Random Access Memory (RAM), Erasable Programmable ROPM (EPROM) and Hard Disk Drive (HDD), for example. Further, the storage unit 226 may be a removable medium, namely, portable storage medium. Such a removable medium includes Universal Serial Bus (USB) memory or a disk storage medium such as Compact Disc (CD) and Digital Versatile Disc (DVD), for example. The storage unit 226 is a computer-readable storage medium.

The optical transmission path 231 connects the semiconductor optical amplifier 220 with the optical demultiplexer 240. The optical demultiplexer 240 demultiplexes the input optical signals into optical signals with wavelength channels λ0 to λ3. Further, the optical demultiplexer 240 outputs the demultiplexed optical signals with wavelength channels λ0 to λ3 to the optical detectors 261 to 263, respectively.

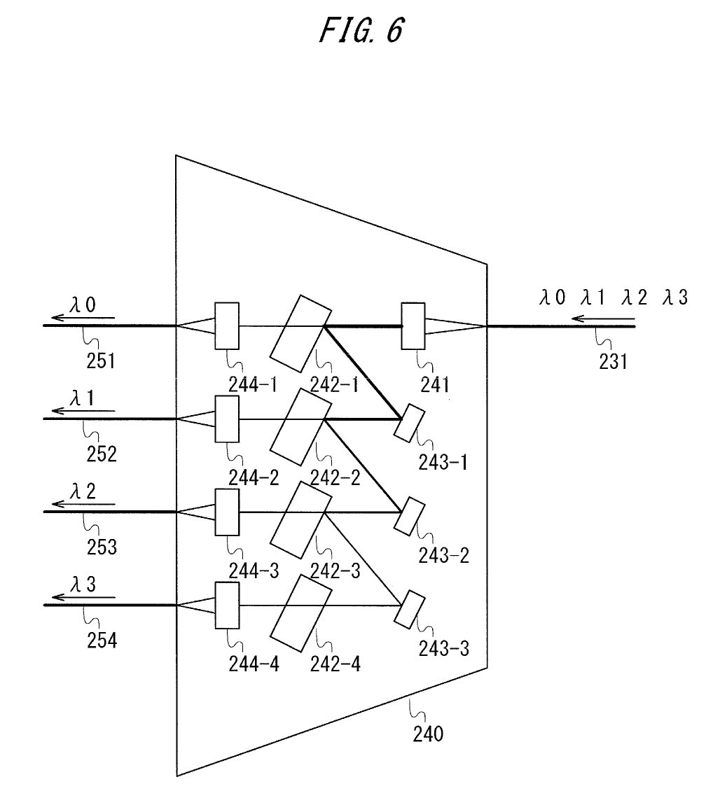

FIG. 6 is a diagram illustrating an example of a configuration of the optical demultiplexer. The optical demultiplexer 240 includes an input-side lens 241, filters 242-1, 242-2, 242-3 and 242-4, mirrors 243-1, 243-2 and 243-3, output-side lenses 244-1, 244-2, 244-3 and 244-4.

The input-side lens condenses optical signals input via the optical transmission path 231 and outputs the condensed optical signals to the filter 242-1.

The filter 242-1 transmits optical signals with wavelength λ0 and reflects optical signals with wavelengths except for λ0.

The filter 242-2 transmits optical signals with wavelength λ1 and reflects optical signals with wavelengths except for λ1. The configuration of the filter 242-2 is similar to the configuration of the filter 242-1. The filter 242-3 transmits optical signals with wavelength λ2 and reflects optical signals with wavelengths except for λ2. The configuration of the filter 242-3 is similar to the configuration of the filter 242-1. The filter 242-4 transmits optical signals with wavelength λ3 and reflects optical signals with wavelengths except for λ3. The configuration of the filter 242-4 is similar to the configuration of the filter 242-1.

The mirror 243-1 reflects optical signals reflected by the filter 242-1. The optical signals reflected by the mirror 243-1 are input to the filter 242-2. The mirror 243-2 reflects optical signals reflected by the filter 242-2. The optical signals reflected by the mirror 243-2 are input to the filter 242-3. The mirror 243-3 reflects optical signals reflected by the filter 242-3. The optical signals reflected by the mirror 243-3 are input to the filter 242-4.

The optical signals transmitted through the filter 242-1 are guided to the optical transmission path 251 by the output-side lens 244-1. The optical signals transmitted through the filter 242-2 are guided to the optical transmission path 252 by the output-side lens 244-2. The optical signals transmitted through the filter 242-3 are guided to the optical transmission path 253 by the output-side lens 244-3. The optical signals transmitted through the filter 242-4 are guided to the optical transmission path 254 by the output-side lens 244-4.

The optical transmission path 251 connects the optical demultiplexer 240 with the optical detector 261. The functions of the optical transmission paths 252, 253 and 254 are similar to the function of the optical transmission path 251.

The optical detector 261 receives optical signals with wavelength channel of λ0 via the optical transmission path 251 and converts the received optical signals into electric signals. The optical detector 261 can be fabricated using a lens and a photodiode (PD), for example. The converted electric signals are processed by an electronic circuit provided at a subsequent stage to the optical detector 261, for example.

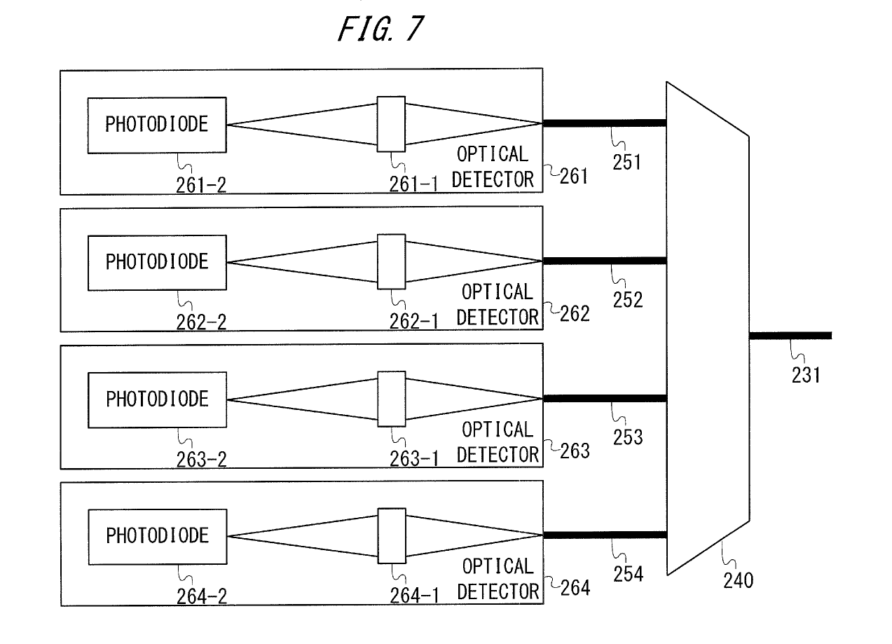

FIG. 7 is a diagram illustrating an example of a configuration of the optical detector. The optical detector 261 in FIG. 7 includes a lens 261-1 and a PD 261-2. The optical detector 262 includes a lens 262-1 and a PD 262-2. The optical detector 263 includes a lens 263-1 and a PD 263-2. The optical detector 264 includes a lens 264-1 and a PD 264-2.

The optical detector 261 is, for example, a Receiver Optical Sub-Assembly (ROSA), which includes a PD chip and an amplifier (Trans-Impedance Amplifier: TIA) for amplifying electric signals to which photoelectric conversion is applied by the PD. The PD chip is, for example, a PIN-PD for wavelength of 1300 nm band and made of InP series material.

The optical detector 262 receives optical signals with wavelength channel of λ1 via the optical transmission path 252 and converts the received optical signals into electric signals. The optical detector 263 receives optical signals with wavelength channel of λ2 via the optical transmission path 253 and converts the received optical signals into electric signals. The optical detector 264 receives optical signals with wavelength channel of λ3 via the optical transmission path 254 and converts the received optical signals into electric signals. The optical detectors 262, 263 and 264 can be fabricated similar to the optical detector 261.

When the intensity of the optical signal input into the PD of each optical detector is equal to or larger than Pmin and equal to or smaller than Pmax, each optical detector can achieve an bit-error-free operation for processing the optical signal. Therefore, the intensity of the optical signal input into the PD of each optical detector should be equal to or larger than Pmin and equal to or smaller than Pmax.

In the present embodiment, it is assumed that the intensity of the optical signal with wavelength λ1 input into the PD 261-2 of the optical detector 261 to the intensity of the optical signal with wavelength λ0 output from the SOA 220 is transmission rate T0 of the optical signal with wavelength λ0. It is also assumed that the intensity of the optical signal with wavelength λ1 input into the PD 262-2 of the optical detector 262 to the intensity of the optical signal with wavelength λ1 output from the SOA 220 is transmission rate T1 of the optical signal with wavelength λ1. It is further assumed that the intensity of the optical signal with wavelength λ2 input into the PD 263-2 of the optical detector 263 to the intensity of the optical signal with wavelength λ2 output from the SOA 220 is transmission rate T2 of the optical signal with wavelength λ2. Moreover, it is assumed that the intensity of the optical signal with wavelength λ3 input into the PD 263-2 of the optical detector 263 to the intensity of the optical signal with wavelength λ3 output from the SOA 220 is transmission rate T3 of the optical signal with wavelength λ3. In addition, the transmission rates T0, T1, T2 and T3 is determined by the configuration of the optical demultiplexer 240, the optical transmission paths 251, 252, 253 and 254, the optical detectors 261, 262, 263 and 264. And the transmission rates T0, T1, T2 and T3 are determined to satisfy the following conditions (1-1) and (1-2). Since the condition (1-1) includes equal signs, the transmission rates of the two adjacent channels can be the same. When the transmission rates of the two adjacent channels are the same, the transmission rates can be increased without attenuating the optical signals. The condition (1-2) indicates that the transmission rate T0 becomes larger than the transmission rate T3. That is, the optical signal having the longest wavelength is attenuated more strongly than the optical signal having the shortest wavelength. Therefore, the more an optical signal with a long wavelength is amplified due to gain tilt, the more strongly the intensity of the optical signal can be attenuated. For example, the values of the transmission rates are stored in the storage unit 226 and the control unit 224 uses the transmission rate to calculate the amount of electric current injected into the semiconductor optical amplifier 220. When the number of wavelength channels is two, for example, the wavelengths λ0 and λ3 should satisfy the condition (1-2).

T0≧T1≧T2≧T3 (1-1)

T0>T3 (1-2)

### Configuration Example 1

In Configuration Example 1, a metal thin film or a dielectric multilayer is formed in the optical demultiplexer 240 to adjust the optical transmission rates T0, T1, T2 and T3.

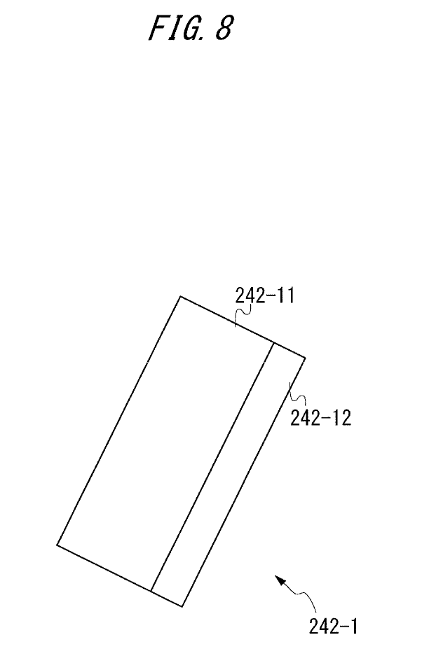

FIG. 8 is a diagram illustrating a configuration example of the filter of the optical demultiplexer. The filter 242 includes, for example, a substrate 242-11 which decreases the transmission loss for wavelength ranging from λ0 to λ3 and a dielectric multilayer 242-12. Optical signals are input from the side of the dielectric multilayer 242-12. The substrate 242-11 is a glass substrate, for example. The wavelength transmitted by the dielectric multilayer 242-12 and the transmission rate of the wavelength of the dielectric multilayer 242-12 can set by changing the film thickness and the design of the layer configuration of the dielectric multilayer 242-12. For example, SiO2/TiO2 or SiO2/Ta2O5 multilayer provided on a glass substrate can be used as the material of the optical filter for a 1300 nm wavelength band. The transmission rate of the filter is adjusted by forming a metal thin film for increasing the transmission loss on the opposite side of the side of the substrate 242-11 on which the electric multilayer 242-12 is formed. For example, the metal thin film is a Ni or Cr film. In addition, the transmission rate of the filter is adjusted by forming a SiO2/TiO2 or SiO2/Ta2O5 multilayer on the opposite side of the side of the substrate 242-11 on which the electric multilayer 242-12 is formed.

It is assumed here that T11 is the optical transmission rate for the wavelength λ0 of the filter 242-1 of the optical demultiplexer 240, T12 is the optical transmission rate for the wavelength λ1 of the filter 242-2 of the optical demultiplexer 240, T13 is the optical transmission rate for the wavelength λ2 of the filter 242-3 of the optical demultiplexer 240 and T14 is the optical transmission rate for the wavelength λ3 of the filter 242-4 of the optical demultiplexer 240. Each optical transmission rate of each filter is set to satisfy the following conditions (2-1) and (2-2).

T11≧T12≧T13≧T14 (2-1)

T11>T14 (2-2)

When each optical transmission rate of each filter satisfies the above conditions, the transmission rates T0, T1, T2 and T3 satisfy the conditions (1-1) and (1-2). A metal thin film or a dielectric multilayer as described above can be formed on the surfaces of the output-side lens 244-1, 244-2, 244-3 and 244-4 instead of adjusting the transmission rate of each filter of the optical demultiplexer 240. In this case, the optical transmission rate of each output-side lens should be set to satisfy the above conditions (2-1) and (2-2). In addition, a metal thin film or a dielectric multilayer as described above can be formed on the end surface of the optical transmission paths 251, 252, 253 and 254 facing the optical demultiplexer 240 instead of adjusting the transmission rate of each filter of the optical demultiplexer 240. In this case, the optical transmission rate at each end surface should be set to satisfy the above conditions (2-1) and (2-2).

According to Configuration Example 1, the intensity of optical signals can be adjusted without changing the configurations of the optical transmission paths 251, 252, 253 and 254 and the optical detectors 261, 262, 263 and 264.

### Configuration Example 2

In Configuration Example 2, the coupling efficiency of the lens of the optical demultiplexer 240 is changed to adjust the optical transmission rates T0, T1, T2 and T3. It is assumed here that the optical transmission rates of the filters in the optical demultiplexer are equal with each other.

Optical signals transmitted through the filters are coupled to the optical transmission paths by the corresponding output-side lenses on the output side in the optical demultiplexer 240. For example, the optical signals with wavelength λ0 transmitted through the filter 242-1 are coupled to the optical transmission path 251 by the output-side lens 244-1. It is assumed here that n11 is the coupling efficiency of the output-side lens 244-1. Similarly, the optical signals with wavelength λ1 transmitted through the filter 242-2 are coupled to the optical transmission path 252 by the output-side lens 244-2. It is assumed here that η12 is the coupling efficiency of the output-side lens 244-2. In addition, the optical signals with wavelength λ2 transmitted through the filter 242-3 are coupled to the optical transmission path 253 by the output-side lens 244-3. It is assumed here that η13 is the coupling efficiency of the output-side lens 244-3. Further, the optical signals with wavelength λ3 transmitted through the filter 242-4 are coupled to the optical transmission path 254 by the output-side lens 244-4. It is assumed here that η14 is the coupling efficiency of the output-side lens 244-4. The respective coupling efficiency is set to satisfy the following conditions (3-1) and (3-2).

η11≧η12≧η13≧η14 (3-1)

η11>η14 (3-2)

When each coupling efficiency satisfies the above conditions, the transmission rates T0, T1, T2 and T3 satisfy the conditions (1-1) and (1-2). The adjustment of the respective coupling efficiency can be achieved by modifying the position at which each output-side lens is fixed to cause defocus. Generally, a lens is fixed by YAG laser welding in the optical demultiplexer for matching the focus of the lens with the light condensing position such as the end surface of the optical fiber and the light receiving surface of the PD. When the light condensing position is modified, the lens is fixed by YAG laser welding at a position at which the focus of the lens and the light condensing position are intentionally displaced with each other to achieve the above defocus, for example.

In Configuration Example 2, the intensity of the optical signal can be adjusted without changing the configuration of the optical transmission paths 251, 252, 253 and 254 and the optical detectors 261, 262, 263 and 264.

### Configuration Example 3

In Configuration Example 3, connection points are provided on the optical transmission paths between the optical demultiplexer and the optical detectors to adjust the optical transmission rates T0, T1, T2 and T3.

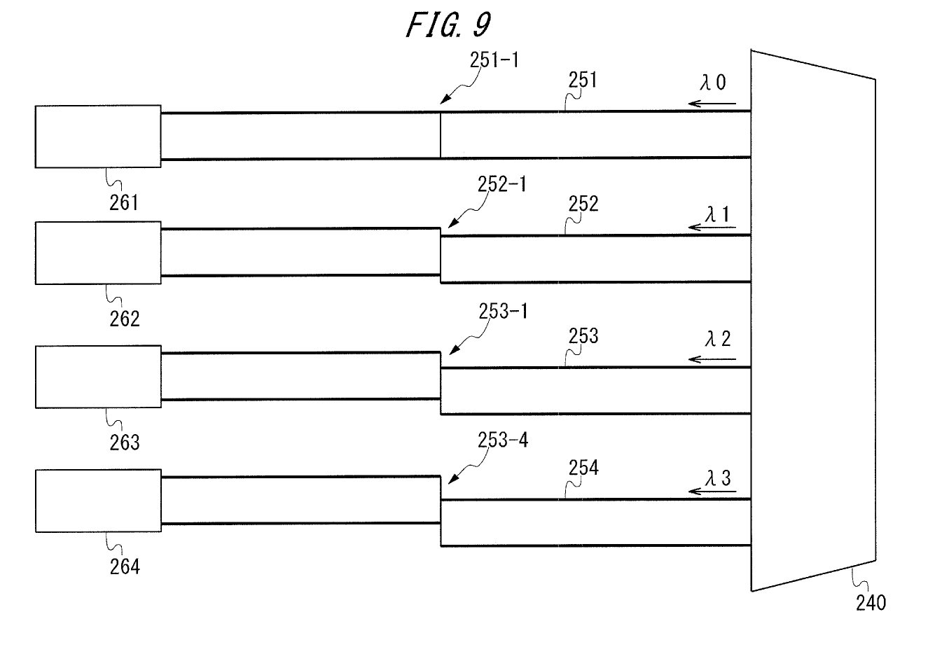

FIG. 9 is a diagram illustrating an example of the optical transmission paths between the optical demultiplexer and the optical detectors in Configuration Example 3. The optical transmission path 251 connecting the optical demultiplexer 240 with the optical detector 261 includes the connection point 251-1. The optical transmission path 252 connecting the optical demultiplexer 240 with the optical detector 262 includes the connection point 252-1. The optical transmission path 253 connecting the optical demultiplexer 240 with the optical detector 263 includes the connection point 253-1. The optical transmission path 254 connecting the optical demultiplexer 240 with the optical detector 264 includes the connection point 254-1. Each optical transmission path is spliced at the respective connection point to displace the optical axes of the optical transmission paths optically connected with each other. The larger of the displacement of the optical axes of the optical coupling at the connection point of the optical transmission path becomes, the smaller the optical transmission rate of the optical transmission path becomes. The optical transmission rate of the optical transmission path is adjusted by adjusting the displacement of the axes of the optical coupling at the connection point of the optical transmission path. It is assumed here that the optical transmission rates of the optical transmission paths 251, 252, 253 and 254 are T21, T22, T23 and T24, respectively. Each transmission rate is adjusted to satisfy the following conditions (4-1) and (4-2).

T21≧T22≧T23≧T24 (4-1)

T21>T24 (4-2)

The optical transmission path 251 may not include the connection point 251-1. When the optical transmission path 251 does not include the connection point 251-1, the optical transmission rate T21 of the optical transmission path 251 is almost 1 and the above conditions are satisfied.

According to Configuration Example 3, the intensity of the optical signals can be adjusted without modifying the configurations of the optical demultiplexer 240 and the optical detectors 261, 262, 263 and 264.

### Configuration Example 4

In Configuration Example 4, the optical transmission rates T0, T1, T2 and T3 are adjusted by the respective configurations of the optical detectors.

The optical signals with wavelength λ0 input into the optical detector 261 are coupled with the PD 261-2 by the lens 261-1. It is assumed that the coupling efficiency is η21. Similarly, the optical signals with wavelength λ1 input into the optical detector 262 are coupled with the PD 262-2 by the lens 262-1. It is assumed that the coupling efficiency is n22. In addition, the optical signals with wavelength λ2 input into the optical detector 263 are coupled with the PD 263-2 by the lens 263-1. It is assumed that the coupling efficiency is n23. Further, the optical signals with wavelength λ3 input into the optical detector 264 are coupled with the PD 264-2 by the lens 264-1. It is assumed that the coupling efficiency is η24. In this case, each coupling efficiency is adjusted to satisfy the following conditions (5-1) and (5-2).

η21≧η22≧η23≧η24 (5-1)

η21>η24 (5-2)

When each coupling efficiency satisfies the above conditions, the transmission rates T0, T1, T2 and T3 satisfy the conditions (1-1) and (1-2).

The adjustment of each coupling efficiency can be achieved by modifying the position at which the lens is fixed, for example.

Metal thin films or dielectric multilayers for causing transmission loss can be formed on the end surface of the optical transmission path 251, the surface of the lens 261-1 of the optical detector 261 and the detection surface of the PD 261-2 to adjust the coupling efficiency to satisfy the conditions (1-1) and (1-2).

According to Configuration Example 4, the intensity of the optical signals can be adjusted without modifying the configurations of the optical demultiplexer 240 and the optical transmission paths 251, 252, 253 and 254.

### Specific Example 1

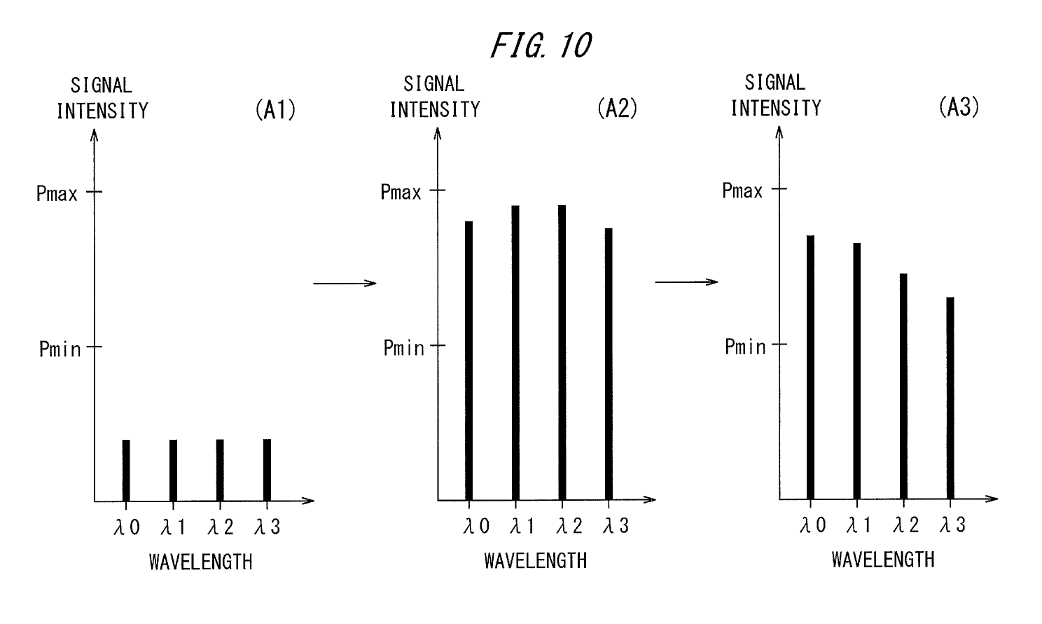

FIG. 10 is a diagram illustrating an example (1) of the intensity of the optical signals received by the optical receiver according to the present embodiment. The horizontal axis of each graph represents the wavelengths of the optical signals and the vertical axis of each graph represents the intensity of the optical signals. The graph A1 in FIG. 10 represents the intensity of the optical signals input into the semiconductor optical amplifier 220. Since the intensity of the optical signals themselves illustrated in the graph A1 is greatly smaller than Pmin of the optical detectors, a larger electric current as illustrated by the electric current I1 in FIG. 2 is input into the semiconductor optical amplifier 220. The graph A2 in FIG. 10 represents the intensity of the optical signals when the optical signals as illustrated in the graph A1 are amplified by and output from the semiconductor optical amplifier 220. Since the electric current such as I1 as illustrated in FIG. 2 is input into the semiconductor optical amplifier 220, a gain tilt does not occur and each optical signal is amplified almost equally. The graph A3 in FIG. 10 represents the intensity of the optical signals detected by the optical detectors when the optical signals as illustrated in the graph A2 are demultiplexed by the optical demultiplexer 240. In the optical demultiplexer 240, each optical transmission path between the optical demultiplexer and each optical detector and each optical detector, the transmission rate is set to be smaller as the wavelength of the optical signal becomes longer. Therefore, the intensity of the optical signals with wavelength λ0, λ1, λ2 and λ3 received by the optical detectors becomes smaller in this order. In addition, the intensity of each optical signal is equal to or larger than Pmin of the respective optical detector and equal to or smaller than Pmax of the respective optical detector.

### Specific Example 2

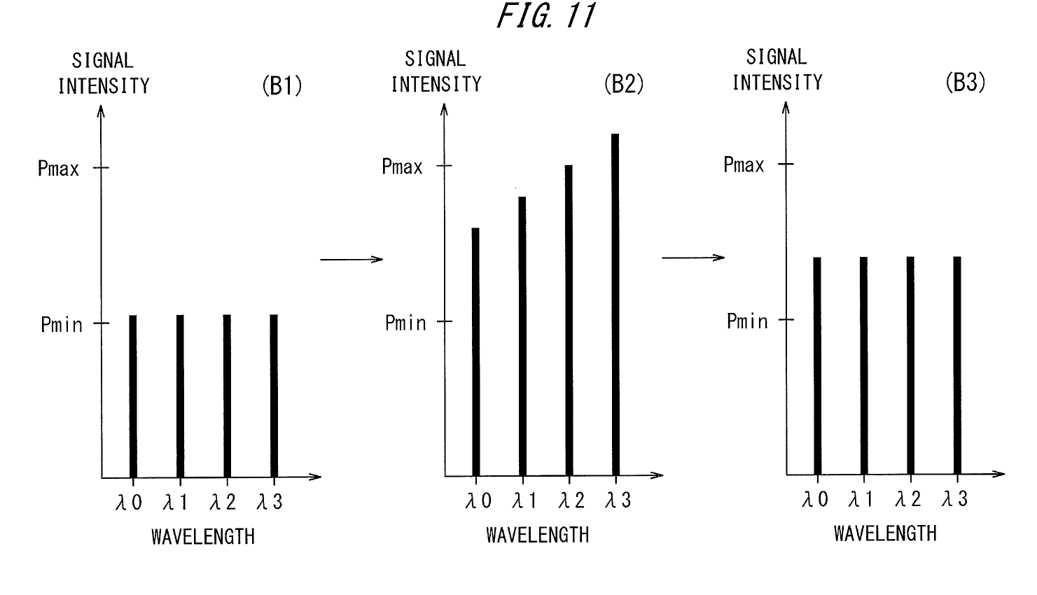

FIG. 11 is a diagram illustrating an example (2) of the intensity of the optical signals received by the optical receiver according to the present embodiment. The horizontal axis of each graph represents the wavelengths of the optical signals and the vertical axis of each graph represents the intensity of the optical signals. The graph B1 in FIG. 11 represents the intensity of the optical signals input into the semiconductor optical amplifier 220. Since the intensity of the optical signals themselves illustrated in the graph B1 is similar to Pmin of the optical detectors, a smaller electric current as illustrated by the electric current I2 in FIG. 2 is input into the semiconductor optical amplifier 220. The graph B2 in FIG. 11 represents the intensity of the optical signals when the optical signals as illustrated in the graph B1 are amplified by and output from the semiconductor optical amplifier 220. Since the electric current such as I2 as illustrated in FIG. 2 is input into the semiconductor optical amplifier 220, a gain tilt occurs. In addition, the larger the wavelength of the optical signal is, the larger the intensity of the optical signal becomes. The graph B3 in FIG. 11 represents the intensity of the optical signals detected by the optical detectors when the optical signals as illustrated in the graph B2 are demultiplexed by the optical demultiplexer 240. In the optical demultiplexer 240, each optical transmission path between the optical demultiplexer and each optical detector and each optical detector, the transmission rate is set to be smaller as the wavelength of the optical signal becomes longer. Therefore, the intensity of the optical signals received by the respective optical detectors becomes almost equal. In addition, the intensity of each optical signal is equal to or larger than Pmin of the respective optical detector and equal to or smaller than Pmax of the respective optical detector.

### Specific Example 3

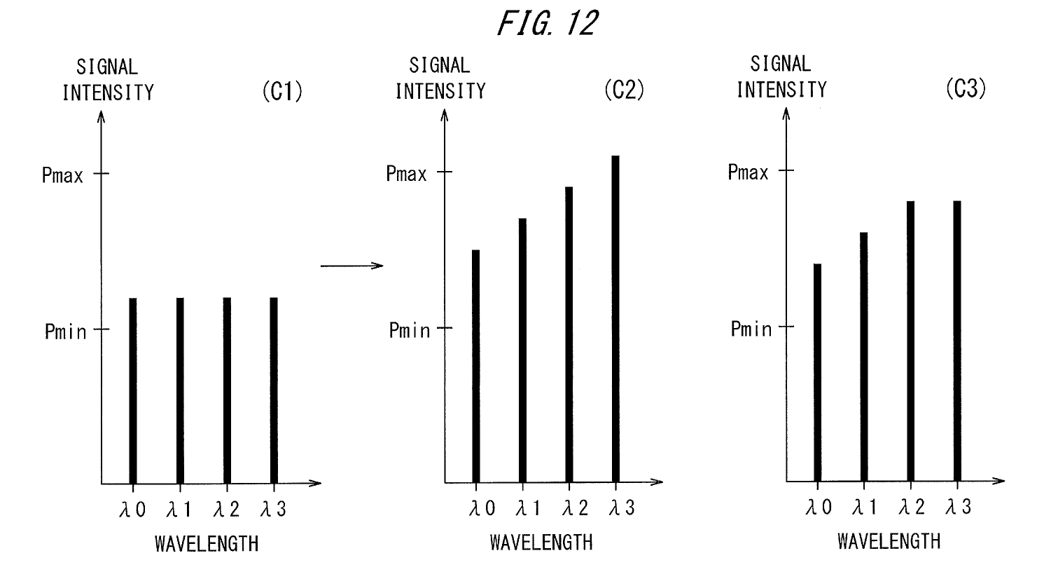

FIG. 12 is a diagram illustrating an example (3) of the intensity of the optical signals received by the optical receiver according to the present embodiment. The horizontal axis of each graph represents the wavelengths of the optical signals and the vertical axis of each graph represents the intensity of the optical signals. The graph C1 in FIG. 12 represents the intensity of the optical signals input into the semiconductor optical amplifier 220. Since the intensity of the optical signals themselves illustrated in the graph C1 is similar to Pmin of the optical detectors, a smaller electric current as illustrated by the electric current I2 in FIG. 2 is input into the semiconductor optical amplifier 220. The graph C2 in FIG. 12 represents the intensity of the optical signals when the optical signals as illustrated in the graph C1 are amplified by and output from the semiconductor optical amplifier 220. Since the electric current such as I2 as illustrated in FIG. 2 is input into the semiconductor optical amplifier 220, a gain tilt occurs. In addition, the larger the wavelength of the optical signal is, the larger the intensity of the optical signal becomes. The graph C3 in FIG. 12 represents the intensity of the optical signals detected by the optical detectors when the optical signals as illustrated in the graph C2 are demultiplexed by the optical demultiplexer 240. In the optical demultiplexer 240, each optical transmission path between the optical demultiplexer and each optical detector and each optical detector, the transmission rate is set to satisfy the following condition.

T0=T1=T2>T3 (6-1)

The above transmission rates satisfy the conditions (1-1) and (1-2) as described above. In the present example, the intensity of the optical signals with wavelength λ3 which is above Pmax of the optical detector is attenuated more greatly than the optical signals with other wavelengths at the stage of the output from the semiconductor optical amplifier 220 and then the intensity of the optical signals with wavelength λ3 becomes equal to or smaller than Pmax. In addition, the intensity of each optical signal is equal to or larger than Pmin of the respective optical detector and equal to or smaller than Pmax of the respective optical detector.

It is noted that the configurations as described above can be combined as long as possible.

### Advantageous Effects of Embodiments

The optical receiver 200 receives optical signals in which optical signals with a plurality of wavelength channels are multiplexed and the semiconductor optical amplifier 220 amplifies the received optical signals. The optical receiver 200 demultiplexes the amplified optical signals by wavelength channels. The optical receiver 200 employs different transmission rates for different wavelength channels to adjust the intensity of the optical signals. By using the optical receiver 200, the intensity of the optical signals detected by the optical detectors can be within a predetermined range even when the gain tilts occur in the semiconductor optical amplifier 220 and then a bit-error-free operation can be achieved for each wavelength channel. The optical receiver according to the above embodiments can suppress the variations of the intensity of the optical signals occurred due to the gain tilts in the semiconductor optical amplifier 220 without increasing the number of parts and the footprint of the optical receiver 200.

All example and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An optical receiver, comprising:
a semiconductor optical amplifier configured to amplify an optical signal in which an optical signal with a first wavelength and an optical signal with a second wavelength are multiplexed;
an optical demultiplexer configured to receive the optical signal amplified by the semiconductor optical amplifier and include a first filter configured to transmit the optical signal with the first wavelength with a transmission rate T1 and a second filter configured to transmit the optical signal with the second wavelength with a transmission rate T2;
a first optical detector configured to receive the optical signal with the first wavelength from the optical demultiplexer; and
a second optical detector configured to receive the optical signal with the second wavelength from the optical demultiplexer,
wherein the transmission rate T1 and the transmission rate T2 satisfy a relation T1>T2.

2. The optical receiver according to claim 1, further comprising a third optical detector configured to receive an optical signal with a third wavelength from the optical demultiplexer,
wherein the semiconductor optical amplifier amplifies an optical signal in which the optical signal with the first wavelength, the optical signal with the second wavelength and the optical signal with the third wavelength are multiplexed,
the optical demultiplexer includes a third filter configured to transmit the optical signal with the third wavelength with a transmission rate T3, and
the transmission rate T1, the transmission rate T2 and the transmission rate T3 satisfy a relation T1≧T3≧T2 and the relation T1>T2.

3. An optical receiver, comprising:
a semiconductor optical amplifier configured to amplify an optical signal in which an optical signal with a first wavelength and an optical signal with a second wavelength are multiplexed; and
an optical demultiplexer configured to receive the optical signal amplified by the semiconductor optical amplifier and include a first filter configured to transmit the optical signal with the first wavelength, a first lens configured to condense the optical signal transmitted by the first filter into a first optical transmission path with a coupling efficiency η1, a second filter configured to transmit the optical signal with the second wavelength and a second lens configured to condense the optical signal transmitted by the second filter into a second optical transmission path with a coupling efficiency η2,
wherein the first optical transmission path connects the optical demultiplexer with a first optical detector and transmits the optical signal with the first wavelength,
the second optical transmission path connects the optical demultiplexer with a second optical detector and transmits the optical signal with the second wavelength,
the first optical detector receives the optical signal with the first wavelength from the optical demultiplexer via the first optical transmission path,
the second optical detector receives the optical signal with the second wavelength from the optical demultiplexer via the second optical transmission path, and
the coupling efficiency η1 and the coupling efficiency η2 satisfy a relation η1>η2.

4. The optical receiver according to claim 3, further comprising a third optical transmission path configured to connect the optical demultiplexer with a third optical detector and transmit an optical signal with a third wavelength with a transmission rate T3,
wherein the third optical detector receives the optical signal with the third wavelength from the optical demultiplexer,
the semiconductor optical amplifier amplifies an optical signal in which the optical signal with the first wavelength, the optical signal with the second wavelength and the optical signal with the third wavelength are multiplexed,
the optical demultiplexer includes a third filter configured to transmit the optical signal with the third wavelength and a third lens configured to condense the optical signal transmitted by the third filter with a coupling efficiency η3 into the third optical transmission path, and
the coupling efficiency η1, the coupling efficiency η2 and the coupling efficiency η3 satisfy a relation η1≧η3≧η2 and the relation η1>η2.

5. An optical receiver, comprising:
a semiconductor optical amplifier configured to amplify an optical signal in which an optical signal with a first wavelength and an optical signal with a second wavelength are multiplexed;
an optical demultiplexer configured to receive the optical signal amplified by the semiconductor optical amplifier and include a first filter configured to transmit the optical signal with the first wavelength and a second filter configured to transmit the optical signal with the second wavelength;
a first optical transmission path configured to connect the optical demultiplexer with a first optical detector and transmit the optical signal with the first wavelength with a transmission rate T1; and
a second optical transmission path configured to connect the optical demultiplexer with a second optical detector and transmit the optical signal with the second wavelength with a transmission rate T2,
wherein the first optical detector receives the optical signal with the first wavelength from the optical demultiplexer via the first optical transmission path,
the second optical detector receives the optical signal with the second wavelength from the optical demultiplexer via the second optical transmission path, and
the transmission rate T1 and the transmission rate T2 satisfy a relation T1>T2.

6. The optical receiver according to claim 5, further comprising a third optical transmission path configured to connect the optical demultiplexer with a third optical detector and transmit an optical signal with a third wavelength with a transmission rate T3,
wherein the third optical detector receives the optical signal with the third wavelength from the optical demultiplexer,
the semiconductor optical amplifier amplifies an optical signal in which the optical signal with the first wavelength, the optical signal with the second wavelength and the optical signal with the third wavelength are multiplexed,
the optical demultiplexer includes a third filter configured to transmit the optical signal with the third wavelength, and
the transmission rate T1, the transmission rate T2 and the transmission rate T3 satisfy a relation T1≧T3≧T2 and the relation T1>T2.

7. An optical receiver, comprising:
a semiconductor optical amplifier configured to amplify an optical signal in which an optical signal with a first wavelength and an optical signal with a second wavelength are multiplexed;
an optical demultiplexer configured to receive the optical signal amplified by the semiconductor optical amplifier and include a first filter configured to transmit the optical signal with the first wavelength and a second filter configured to transmit the optical signal with the second wavelength;
a first optical detector configured to receive the optical signal with the first wavelength which is transmitted with a transmission rate T1 from the optical demultiplexer; and
a second optical detector configured to receive the optical signal with the second wavelength which is transmitted with a transmission rate T2 from the optical demultiplexer,
wherein the transmission rate T1 and the transmission rate T2 satisfy a relation T1>T2.

8. The optical receiver according to claim 7, further comprising a third optical detector configured to receive an optical signal with a third wavelength which is transmitted with a transmission rate T3 from the optical demultiplexer,
wherein the semiconductor optical amplifier amplifies an optical signal in which the optical signal with the first wavelength, the optical signal with the second wavelength and the optical signal with the third wavelength are multiplexed,
the optical demultiplexer includes a third filter configured to transmit the optical signal with the third wavelength, and
the transmission rate T1, the transmission rate T2 and the transmission rate T3 satisfy a relation T1≧T3≧T2 and the relation T1>T2.
